(19) United States
(12) Patent Application Publication
(10) Pub. No.: US 2007/0251870 A1
(43) Pub. Date: Nov. 1, 2007

(54) Chromatographic stationary phase

(75) Inventors: John W. Henderson, Landenberg, PA (US); Loren Linder, Warminster, PA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: Agilent Technologies, Inc., Palo Alto, CA (US)

(21) Appl. No.: 11/415,463

(22) Filed: May 1, 2006

(51) Int. Cl. B01D 15/08

(52) U.S. Cl. 210/198.2; 502/401; 428/403

(57) ABSTRACT

A surface moiety for use in chromatography which is attached to a solid support, said surface moiety having a structure which comprises at least two arylene groups wherein the arylene groups are separated from each other by a hydrocarbylene group. The surface moiety is attached to a solid support to form a stationary phase material. Methods for making the stationary phase material and using the material are provided also as are a chromatography apparatus which contains the material and a surface modifying agent which may be used to attach the surface moiety to the solid support.

### BACKGROUND

Chromatography is a method used to separate species, e.g., chemical compounds, contained in a sample. Chromatography may be used also for analyzing the purity of a specie and/or for characterizing a specie. In chromatography, the sample is contained in a carrier phase (also known as the “mobile phase”), for example, a liquid solution, which is contacted with a stationary phase, for example, chromatography beads. The species in the sample may have differing affinity with the stationary phase. Those with a greater affinity to the stationary phase are retarded by their contact with the stationary phase to a greater extent than those with a lesser affinity. Species with differing affinities are, therefore, separated.

There are different forms of chromatography. In liquid chromatography (LC), the carrier phase comprises a liquid, for example, water and, optionally, an organic solvent. In gas chromatography (GC), the carrier phase comprises a gas. In supercritical fluid chromatography (SFC), the carrier phase comprises a supercritical fluid, for example, supercritical carbon dioxide and, optionally, an organic solvent.

The stationary phase is typically comprised of a stationary phase material which comprises a solid support and a surface moiety. The affinity of a specie for the stationary phase is determined, primarily, by the interaction of the specie with the surface moiety. For example, a stationary phase which has surface cationic moieties will retard the passage of an anionic specie relative to the passage of cationic or neutral species. The surface moiety may be incorporated into a stationary phase material by reacting the solid support thereof with a surface modifying agent which comprises the moiety. The reaction results in the covalent attachment of the moiety to the solid support.

### SUMMARY

The present invention relates to a surface moiety for use in chromatography which is attached to a solid support, said surface moiety having a structure according to the following formula 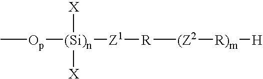
wherein: Z¹ and each Z² is independently a hydrocarbylene group of 1 to 10 carbon atoms which may be substituted or not substituted; each R is independently an arylene group of 6 to 14 carbon atoms which may be substituted or not substituted; each X is independently a hydrocarbyl group of 1 to 6 carbon atoms, a hydrocarbyloxy group of 1 to 6 carbon atoms, an oxygen atom, or a bond at which the surface moiety is attached to the solid support; n is 0 or 1; p is 0 or 1; and m is an integer from 1 to 4, inclusive.

Another aspect of the present invention is a surface modifying agent for use in attaching the aforementioned surface moiety to a solid support.

A further aspect of the present invention is a stationary phase material for use in chromatography which comprises a solid support that has, covalently bonded thereto, the aforementioned surface moiety.

Yet another aspect of the present invention is a method for making the aforementioned stationary phase material.

Yet another aspect of the present invention is a chromatography apparatus comprising the aforementioned stationary phase material.

Yet another aspect of the present invention is a method for performing chromatography comprising passing a sample containing a specie to be separated through the aforementioned chromatography apparatus.

### DETAILED DESCRIPTION

A. Definitions

The term “moiety” refers to a portion of a molecule, including one atom portions.

The term “hydrocarbon” refers to a molecule or a moiety comprising only hydrogen and carbon atoms, except where substituted. A hydrocarbon may be straight or branched-chain or may be cyclic and may include one or more cyclic groups. A hydrocarbon may be saturated, i.e., all of the carbon-carbon bonds therein are single bonds, or an unsaturated, i.e., some or all of the carbon-carbon bonds therein are double or triple bonds.

The term “hydrocarbyl”, by itself, or as part of another moiety, refers to a univalent hydrocarbon moiety which may be straight or branched-chained, saturated or unsaturated.

The term “hydrocarbylene”, by itself, or as part of another moiety, refers to a divalent hydrocarbon moiety which may be straight or branched-chained, saturated or unsaturated.

The term “hydrocarbyloxy”, by itself, or as part of another moiety, refers to a monovalent moiety of the formula —O-hydrocarbyl.

The term “alkyl”, by itself, or as part of another moiety (e.g., cyanoalkyl), refers to a univalent saturated hydrocarbon moiety.

The term “alkylene”, by itself, or as part of another moiety, refers to a divalent saturated hydrocarbon group.

The term “alkoxy”, by itself, or as part of another moiety, refers to a monovalent moiety of the formula —O-alkyl.

The term “substituted”, when used as an adjective to describe a molecule or moiety, means that one or more hydrogen atoms on the molecule or moiety has been replaced by another atom or a chemical group. Substitution may be at any position that is chemically and sterically accessible. Each individual replacement atom or chemical group may be different from one another. When a particular atom or chemical group is indicated as a substituent, it means that a hydrogen atom on the molecule or moiety is replaced by that atom or chemical group. For example, a chlorine-substituted hydrocarbon refers to a hydrocarbon on which one of the hydrogen atoms has been replaced by a chorine atom. As another example, an alkyl-substituted hydrocarbon refers to a hydrocarbon on which one of the hydrogen atoms has been replaced by an alkyl.

The term “substituent” refers to the atom or chemical group which replaces a hydrogen in a substituted molecule or moiety.

The term “aryl”, by itself, or as part of another radical, refers to a univalent aromatic moiety, for example, phenyl. Included in this term are moieties comprising two or more fused aromatic rings such as napthyl as well as moieties which contain two or more aromatic rings in tandem such as biphenyl.

The term “arylene”, by itself, or as part of another radical, refers to a divalent aromatic moiety.

The term “phenyl”, by itself, or as part of another radical, refers to a univalent 6-member aromatic hydrocarbon ring moiety.

The term “phenylene”, by itself, or as part of another radical, refers to a divalent 6-member aromatic hydrocarbon ring moiety.

The term “leaving group” refers to an element or a chemical group that is displaced from a molecule during a reaction.

The term “metal” refers to an element which is lustrous, ductile, generally electropositive, and that is a conductor of heat and electricity as a result of having an incompletely filled valence shell.

The term “metal oxide” refers to a compound of a metal and oxygen.

The term “metalloid” refers to an element which demonstrates properties which are intermediate between the properties of typical metals and typical non-metals. For example, a metalloid may be an element which has the physical appearance and properties of a metal (as defined above) but behaves chemically as a non-metal. Examples of metalloids include silicon, boron, arsenic, bismuth, germanium, antimony, and tellurium.

The term “metalloid oxide” refers to a compound of a metalloid and oxygen.

The term “reactive chemical group” refers to a chemical group on a compound which is directly involved in the making or breaking of a chemical bond during a chemical reaction. Examples of reactive chemical groups include primary and secondary amino groups, hydroxyl groups, thiol groups, and leaving groups.

The term “stationary phase material” refers to a material which is a constituent of a stationary phase used in chromatography. Examples of stationary phase materials include chromatography beads and chromatography plates. The stationary phase material typically comprises a solid support and a surface moiety.

The term “surface moiety” refers to a moiety which is covalently attached to the solid support of a stationary phase material and which plays a role in the separation of species contained in a sample in a carrier phase by virtue of the differing affinities to the moiety of the various species contained in the sample.

The term “surface modifying agent” refers to a compound which reacts with a reactive chemical group contained on a solid support resulting in the covalent attachment of a surface moiety onto the solid support.

B. Description of the Stationary Phase Material

The present invention relates to a stationary phase material for use in chromatography which comprises a solid support, ⊙, that has, covalently attached thereto, at least one surface moiety according to Formula I: 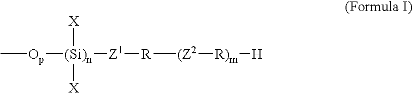
wherein: Z¹ and each Z² is independently a hydrocarbylene group of 1 to 10 carbon atoms which may be substituted or not substituted; each R is independently an arylene group of 6 to 14 carbon atoms which may be substituted or not substituted; each X is independently a hydrocarbyl group of 1 to 6 carbon atoms, a hydrocarbyloxy group of 1 to 6 carbon atoms, an oxygen atom, or a bond at which the surface moiety is attached to the solid support; n is 0 or 1; p is 0 or 1; and m is an integer from 1 to 4, inclusive.

The stationary phase material may be in various forms, for example, beads, rods, plates, films, sheets, and fibers.

The stationary phase material of the present invention is useful when it is desired to separate an aromatic specie from a non-aromatic specie. The use of a surface moiety having an aromatic group allows for such separation because an aromatic specie exhibits greater affinity with a surface moiety containing an aromatic group as compared with a non-aromatic specie. This is due to the interactions between the pi bonds of the aromatic specie and the aromatic groups on the surface moiety.

In performing chromatography, it is often desired to increase the level of the separation of species contained in a sample (resolution). There is a continuing need for new stationary phase materials which provide improved resolution. An improvement in resolution can be accomplished by the use of a stationary phase material having a greater affinity for the specie desired to be separated from another specie in a sample as compared with other stationary phase materials.

It is known in the art that the greater the number of aromatic groups present in the surface moiety of a stationary phase material, the greater the resolution of the separation of an aromatic specie is from a non-aromatic specie.

The stationary phase material of the present invention contains a surface moiety having at least two arylene groups, thus improving upon stationary phase materials having a surface moiety with only one arylene group. In addition, while the use of stationary phase materials containing one biphenyl group is known in the art, applicants have further discovered that the use of a surface moiety comprising arylene groups which are separated from each other by a hydrocarbylene group allows for more efficient separation of aromatic groups from non-aromatic groups due to the larger size of the moiety. Accordingly, the stationary phase material of the present invention contains the additional improvement in that the arylene groups of a surface moiety thereon are separated by a hydrocarbylene group.

In addition to the above improvements, in embodiments in which the Z¹ group has 2 or more carbons, the use of such a Z¹ group is also an improvement as the resulting surface moiety is less bulky at the point of attachment to the solid support as compared with arylene-containing surface moieties in which there is either no hydrocarbyl group between the point of attachment of the moiety to the solid support and the arylene group or a hydrocarbyl group having less than 2 carbons. As compared with surface moieties of the prior art, therefore, the surface moiety of the present invention exerts reduced steric hinderance against other surface moieties which may attach to the solid support. This allows for greater amounts of surface moieties to attach to the solid support. In the case where additional moieties of the present invention are to be added to the solid support, thus further allows for increased resolution as greater amounts of aromatic groups are present in the stationary phase.

C. The Surface Moiety

Essentially any moiety which has a chemical formula according to Formula I may be used as a surface moiety in the practice of the present invention.

According to an embodiment of the invention, the Z¹ group is butylene.

According to another embodiment of the invention, each R group is phenylene.

According to yet another embodiment, n is 1, and each X is individually methyl, isopropyl, or isobutyl.

According to yet another embodiment, n is 1, and each X is an additional bond at which the surface moiety is attached to the solid support.

According to yet another embodiment, n is 1, and each X is an oxygen atom.

According to yet another embodiment, the Z¹ group is a butylene group which may be substituted or not substituted, each Z² group is ethylene which may be substituted or not substituted, and each R group is a phenylene group which may be substituted or not substituted.

In the above embodiments, Z¹, each Z² group, each X group, and each R group may be substituted. Substitutents which may be used in the practice of the present invention include, for example: halogens; —C(halogen)₃, for example —CF₃; cyano; vinyl; hydroxyl; thiol; nitro; hydrocarbyl groups of 1 to 7 carbon atoms; hydrocarbyloxy groups of 1 to 7 carbon atoms; oxo; epoxide; —S-hydrocarbyl groups wherein the hydrocarbyl has 1 to 7 carbon atoms; —S—O-hydrocarbyl groups wherein the hydrocarbyl has 1 to 7 carbon atoms; —SO₂-hydrocarbyl groups wherein the hydrocarbyl has 1 to 7 carbon atoms; —CO₂-hydrocarbyl groups wherein the hydrocarbyl has 1 to 7 carbon atoms; a cation exchanger, for example, —CO₂H or —SO₃H; an anion exchanger, for example, —NH₂, —NH-hydrocarbyl wherein the hydrocarbyl group has 1 to 6 carbon atoms, and —N(hydrocarbyl)₂ wherein each hydrocarbyl group has 1 to 6 carbon atoms; —C(O)-hydrocarbyl groups wherein the hydrocarbyl has 1 to 7 carbon atoms; —C(O)—NH₂; —C(O)—NH-hydrocarbyl groups wherein the hydrocarbyl has 1 to 7 carbon atoms; —C(O)-N(hydrocarbyl)₂ wherein each hydrocarbyl group independently has 1 to 7 carbon atoms; and trimethylsilyl. In addition, substituents may be derived from other compounds, for example: urea; peptides; proteins; carbohydrates; haptens; and nucleic acids.

D. The Solid Support

Essentially any suitable material may be used as the solid support, ⊙, of the stationary phase. The solid support may comprise a metal oxide and/or a metalloid oxide. Examples of metal oxides for use in the present invention include zirconia, titania, chromia, alumina, and tin oxide. Examples of metalloid oxides for use in the present invention include silica and hybrid silica.

The solid support may comprise entirely of a metal oxide or a metalloid oxide or comprise a substrate which is coated with a metal oxide or a metalloid oxide. The solid support may comprise more than one type of metal oxide or metalloid oxide. For example, the solid support may comprise titania coated with silica.

The solid support may be in various forms, for example, beads, rods, plates, films, sheets, and fibers. Typically, the form of the solid supports dictates the form of the solid phase material of which it is a part as the surface moiety is added to the surface of the solid support.

In embodiments of the present invention in which the stationary phase material is in the form of a bead, the solid phase material may be a microparticle. The microparticle may exist in various sizes and shapes. An example of a microparticle is a microsphere. Microspheres used in the practice of the present invention may have an “average diameter” in an amount, for example, ranging in size from about 1.0 to about 50 microns, from about 1 to about 30 microns, or from about 1 to about 15 microns. The term “average diameter” refers to the statistical average of the spherical diameters of the microspheres. The microspheres may be substantially uniform in size, meaning that less than about 5% of the microspheres have a diameter of less than about 0.5 times the average diameter and less than 5% have a diameter greater than 1.5 times the average diameter. In some embodiments, less than about 5% of the microspheres have a diameter of less than about 0.8 times the average diameter and less than 5% have a diameter greater than 1.2 times the average diameter.

In embodiments of the present invention in which the stationary phase material is in the form of a plate, the plate may be of various sizes and shapes, for example, a rectangle having dimensions of from about 0.5 inches to about 8 inches by from about 2 inches to about 11 inches.

In some embodiments, the solid support is porous so as to increase the surface area of the stationary phase material of which it is a part. For example, the volume of the pores may be from about 40 to about 80% of the total volume of the particle with the pores being of a size of from about 50 to about 1000 Angstroms in diameter.

In some embodiments, the solid support has a surface which comprises a reactive chemical group that is capable of reacting with a surface modifying agent which attaches the surface moiety to the solid support.

In an embodiment of the present invention, a metal oxide or a metalloid oxide on the surface of the solid support is derivatized to form a reactive chemical group. For example, the metal oxide or metalloid oxide may be derivatived so that the oxide becomes a hydroxyl group (for example, silica may be derivatized into silanol). In another example, the metal oxide or metalloid oxide may be derivatized so that the oxide is replaced by a leaving group (e.g., F, Cl, Br, an alkoxy group of 1 to 6 carbon atoms, and —NR₁R₂ with R₁ and R₂ being each, individually, an alkyl having 1 to 3 carbon atoms). In yet another example, the metal oxide or metalloid oxide may be derivatized so that the oxide is replaced by hydrogen.

Hydroxylated porous silica beads (5 micron diameter, 80 Angstrom diameter pore size) may be obtained from Agilent Technologies, Palo Alto, Calif.

E. The Surface Modifying Agent

A surface modifying agent may be used to attach the surface moiety to the solid support. Any surface modifying agent which is capable of attaching the desired surface moiety to the solid support may be used in the practice of the present invention.

An example of such a surface modifying agent is a compound of Formula II:
QₜM (Formula II)
wherein M is a surface moiety of Formula I, Q is a group which is displaced during the reaction of the surface modifying agent with a reactive chemical group on the solid support, ⊙, to form a compound of the structure ⊙-M, and t is an integer from 0 to 3, inclusive. In embodiments of the invention in which t is 2 or 3, the surface modifying agent may react with 2 or 3, respectively, reactive chemical groups on the solid support or may react with another surface modifying agent to form a crosslink or an additional layer of surface moieties. When n and p are 0, the Q group may be bonded to M at Z¹. When p is 1 and n is 0, the Q group may be bonded to the oxygen of (O)ₚ. When n is 1 and p is 1, Q groups may be bonded to the oxygen of (O)ₚ and to the X groups (when X is a bond, the Q groups may be bonded directly to the silicon). When n is 1 and p is 0, the Q groups may be bonded to the X groups and directly to the silicon.

In an embodiment of the present invention, the surface modifying agent is a compound of Formula II in which Q is a leaving group (e.g., F, Cl, Br, an alkoxy group of 1 to 6 carbon atoms, and —NR₁R₂ with R₁ and R₂ being each, individually, an alkyl having 1 to 3 carbon atoms). Such a surface modifying agent may, for example, be reacted with a solid support which comprises a metal oxide or a metalloid oxide which has been derivatized so that the oxide has been changed to a hydroxyl group. In the reaction, the hydrogen of the hydroxyl group is displaced and the oxygen of the hydroxyl group covalently binds to the surface moiety (M), displacing the leaving group (Q). In embodiments in which t is 2 or 3, the surface modifying agent may react with 2 or 3, respectively, derivatized metal oxides or metalloid oxides on the solid support or may react with another surface modifying agent to form a crosslink or an additional layer of surface moieties. The surface moiety (M) is thus covalently bound to the metal oxide or metalloid oxide.

In another embodiment of the present invention, the surface modifying agent is a compound of Formula II in which Q is hydrogen and is bonded to the oxygen of the (O)ₚ group, if present, or to an X group which is oxygen. In such an embodiment, the surface modifying agent has a reactive hydroxyl group. Such a surface modifying agent may, for example, be reacted with a solid support which comprises a metal oxide or a metalloid oxide which has been derivatized so that the oxide has been replaced by a leaving group (e.g., F, Cl, Br, an alkoxy group of 1 to 6 carbon atoms, and —NR₁R₂ with R₁ and R₂ being each, individually, an alkyl having 1 to 3 carbon atoms). In the reaction, the hydrogen of the hydroxyl group is displaced and the oxygen of the hydroxyl group covalently binds to the solid support, displacing the hydrogen (Q). In embodiments in which t is 2 or 3, the surface modifying agent may react with 2 or 3, respectively, derivatized metal oxides or metalloid oxides on the solid support or may react with another surface modifying agent to form a crosslink or an additional layer of surface moieties. The surface moiety (M) is thus covalently bound to the metal oxide or metalloid oxide.

A surface modifying agent can include both a Q group is hydrogen and a Q group that is a leaving group. In such cases, each individual Q group may be bonded to M as described above.

In yet another embodiment of the present invention, the surface modifying agent is a compound of the following formula
H-Z¹-R-(Z²-R)ₘ—H (Formula III)
Wherein the variables are as defined above in Formula I provided that Z¹ is an unsaturated hydrocarbylene group in which the two carbon atoms furthest from the R group are joined with a double bond. Such a surface modifying agent may, for example, be reacted with a solid support which comprises a metal oxide or a metalloid oxide which has been derivatized so that the oxide has been replaced with a hydrogen atom. In the reaction, the hydrogen which replaced the oxide on the derivatized solid support saturates the aforementioned double bond, thus covalently binding the surface moiety (M).

A surface modifying agent may be made using Grignard reactions. For example, to produce a surface modifying agent in which m is 1, a compound of the formula H—R-Z²-Cl may be reacted with magnesium to form H—R-Z²-MgCl. This is then reacted with a compound of the formula Cl-Z²-R-Z¹-Cl to form a surface modifying agent of the formula H—R-Z²-Z²-R-Z¹-Cl (the formula H—R-Z²-Z²-R-Z¹-Cl may be written also as H—R-Z²-R-Z¹-Cl given the definition of Z²). In situations where m is 2, the above-described H—R-Z²-MgCl compound may be reacted with a compound of the formula Cl-Z²-R-Z²-Cl to form a compound of the formula H—R-Z²-R-Z²-Cl which is then reacted with magnesium to form a compound of the formula H—R-Z²-R-Z²-MgCl. This compound may then be reacted with a compound of the formula Cl-Z²-R-Z¹-Cl to form a surface modifying agent of the formula H—(R-Z²)ₘ-R-Z¹-Cl where m is 2. A similar reaction scheme may be utilized to produce surface modifying agents in which m is 3 or 4.

In embodiments in which n of Formula I is 1, the surface modifying agent may be prepared by reacting the above prepared compound with a compound of Formula IV 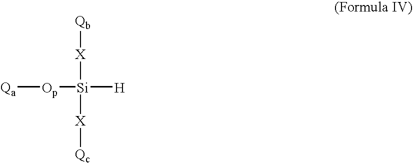
, wherein X, Q, and p are as defined above; and a, b, and c are each independently 0 or 1, provided that a+b+c=t. The reaction can take place using a catalyst, for example a platinum catalyst (e.g., PtCl₄, chloroplatinic acid in isopropanol acetone or THF, and Karstedt's catalyst) at a temperature from about 20 to about 200° C. The resulting product is a compound of the formula 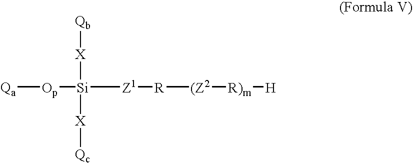
E. Preparation of the Stationary Phase Material

The stationary phase material of the present invention may be made by attaching a surface moiety of Formula I (M) to a solid support, ⊙, to form a compound of the structure ⊙-M.

This may be accomplished by reacting the solid support with a surface modifying agent. As stated above, examples of surface modifying agents for use in the present invention include those of Formula II:
QₜM (Formula II)
wherein M is a surface moiety of Formula I, Q is a group which is displaced during the reaction of the surface modifying agent with a reactive chemical group on the solid support, ⊙, to form a stationary phase material of the structure ⊙-M, and t is an integer from 1 to 3, inclusive.

To allow for the solid support to react with the surface modifying agent, it may be necessary to add a reactive chemical group to the support. This may be accomplished, for example, by derivatizing a surface metal oxide or metalloid oxide thereon.

A general discussion of the reaction a surface modifying agent with a solid support is provided in “An Introduction to Modern Liquid Chromatography”, L. R. Snyder and Kirkland, J. J., Chapter 7, John Wiley and Sons, New York, N.Y. (1979), the entire disclosure of which is incorporated herein by reference. The reaction of a surface modifying agent with a porous solid support is described in “Porous Silica”, K. K. Unger, page 108, Elsevier Scientific Publishing Co., New York, N.Y. (1979), the entire disclosure of which is incorporated herein by reference. A description of the reaction of a surface modifying agent with a variety of solid support materials is provided in “Chemistry and Technology of Silicones”, W. Noll, Academic Press, New York, N.Y. (1968), the entire disclosure of which is incorporated herein by reference.

In an embodiment of the present invention, the surface modifying agent is reacted with the solid support in a suitable organic solvent or mixture of organic solvents, for example, toluene, xylene, mesitylene, and mixtures thereof. The reaction may be performed at an elevated temperature, for example, from about 50° C. up to the reflux temperature of the solvent or solvent mixture.

In one embodiment, the surface metal oxide or metalloid oxide of the solid support is derivatized so that the oxide becomes a hydroxyl group (for example, silica may be derivatized into silanol). This may be accomplished by, for example, contacting the metal oxide or metalloid oxide with water (for example, boiling the solid support comprising the metal oxide or metalloid oxide in water); contacting the metal oxide or metalloid oxide with dilute nitric acid (for example, boiling the solid support comprising the metal oxide or metalloid oxide in dilute nitric acid); or hydrothermal treatment with steam. One method involves contacting the metal oxide or metalloid oxide with water in the presence of HF or at least one basic activator selected from the group consisting of quarternary ammonium hydroxides, ammonium hydroxide, and organic amines at a temperature of from about ambient temperature to about 100° C. as described in U.S. Pat. No. 5,032,266 to Kirkland et al. The derivatized solid support may then be reacted with a surface modifying agent of Formula II in which Q is a leaving group (e.g., F, Cl, Br, an alkoxy group of 1 to 6 carbon atoms, and —NR₁R₂ with R₁ and R₂ being each, individually, an alkyl having 1 to 3 carbon atoms), p is 0 and t is 1 to 3. The reaction may take place in a suitable organic solvent or mixture of organic solvents, as described above, at an elevated temperature, for example, from about 50° C. up to the reflux temperature of the solvent or solvent mixture. The reaction scheme is
QₜM+ [symbol] -OH→ [symbol] -O-MQₜ₋₁+HQ,
wherein [symbol] represents the structure of the derivatized solid support without the hydroxyl group which is being reacted with the surface modifying agent (the reaction is being diagrammed as such for the convenience of the reader). Accordingly, [symbol] -O-MQₜ₋₁ is the same as ⊙-MQₜ₋₁. In embodiments in which t is 2 or 3, MQₜ₋₁ may undergo further reactions with another hydroxyl group on the derivatized solid support to form a compound having the structure ⊙-M, wherein M is attached by two or more bonds to the solid support and/or may react with another surface modifying agent to form a crosslink or an additional layer of surface moieties.

In another embodiment, the surface metal oxide or metalloid oxide of the solid support is derivatized so that the oxide is replaced by a leaving group (e.g., F, Cl, Br, an alkoxy group of 1 to 6 carbon atoms, and −NR₁R₂ with R₁ and R₂ being each, individually, an alkyl having 1 to 3 carbon atoms). This may be accomplished by, for example, the methods described in U.S. Pat. No. 5,326,738, which is incorporated herein by reference. The derivatized solid support may then be reacted with a surface modifying agent of Formula II in which Q is a hydrogen which is bonded to the oxygen of the Oₚ group or to an X group that is oxygen and t is 1 to 3. The reaction may take place in a suitable organic solvent or mixture of organic solvents, as described above, at an elevated temperature, for example, from about 50° C. up to the reflux temperature of the solvent or solvent mixture. The reaction scheme is
M(OH)ₜ+ [symbol] -L→ [symbol] -O-M(OH)ₜ₋₁+HL,
wherein [symbol] represents the structure of the derivatized solid support without the leaving group which is being reacted with the surface modifying agent (the reaction is being diagrammed as such for the convenience of the reader) and L represents the leaving group. Accordingly, [symbol] -O-M(OH)ₜ₋₁ is the same as ⊙-M(OH)ₜ₋₁. In embodiments in which t is 2 or 3, MQₜ₋₁ may undergo further reactions with the derivatized solid support to form a compound having the structure ⊙-M, wherein M is attached by two or more bonds to the solid support and/or may react with another surface modifying agent to form a crosslink or an additional layer of surface moieties.

In yet another embodiment, the surface metal oxide or metalloid oxide of the solid support is derivatized so that the oxide is replaced by hydrogen. This may be accomplish by, for example, the methods described in U.S. Pat. No. 5,017,540 and 5,326,738, which are incorporated herein by reference. The derivatized solid support is then reacted with a surface modifying agent of the formula
H-Z¹-R-(Z²-R)ₘ—H
Wherein the variables are as defined above in Formula I provided Z¹ is an unsaturated hydrocarbylene in which the 2 carbon atoms furthest from the R group are joined by a double bond. The reaction may take place in the presence of a platinum catalyst in a suitable organic solvent or mixture of organic solvents, as described above, at an elevated temperature, for example, from about 20° C. up to the reflux temperature of the solvent or solvent mixture. The hydrogen which replaced the oxide on the derivatized solid support serves to saturate the aforementioned double bond. The final product is a compound of the formula ⊙-M wherein M represents a surface moiety of Formula I. As an example of this reaction, in an embodiment in which the derivatized solid support is reacted with a compound of Formula I in which Z¹ is an unsaturated butylene group having an initial double bond, the reaction is as follows. [symbol]
-H+CH₂═CH—CH₂—CH₂—R-(Z²-R)ₘ—H→^{pt} [symbol] -(CH₂)₄—R-(Z²-R)ₘ—H,
wherein [symbol] represents the structure of the derivatized solid support without the leaving group which is being reacted with CH₂═CH—CH₂—CH₂—R-(Z²-R)ₘ—H (the reaction is being diagrammed as such for the convenience of the reader), and R, Z², and m are as defined above for Formula I. The above reaction attaches a surface moiety of Formula I in which the Z¹ is a saturated butylene group.

In the preparation of the stationary phase material, more than one type of surface moiety may be attached to the solid support. In the preparation of the stationary phase material, the different surface moieties may be attached in a one step reaction. The relative amounts of each of the surface moieties which are incorporated into the stationary phase material may be controlled by, for example, controlling the ratio of the different moieties or surface modifying agents which attach said moieties that are reacted with the solid support. The relative amounts of each of the moieties which are incorporated into the stationary phase material may also be influenced by differences in the reactivity of the moiety or surface modifying agent which attaches the moiety with the solid support. Such differences may be due to the presence of different chemical groups on the moiety or surface modifying agent and differences in the steric bulk of the moiety (for larger and/or more sterically demanding moieties, fewer of the total available reactive positions on the solid support may physically be reacted).

Alternatively, one type of surface moiety may be first attached to the solid support in a first reaction and then another type of surface moiety may be attached to the solid support in a second reaction. The sequential reactions may be performed with or without isolation of the immediate product after each of the reactions. The relative amounts of each of the surface moieties which are incorporated into the stationary phase material may be controlled by controlling the amount of each moiety or surface modifying agent attaching the moiety that is reacted with the solid support. This may be accomplished by, for example, controlling the stoichiometry of the reaction or controlling the reaction conditions (e.g., time, reaction temperature, and concentration of reagents). The relative amounts of each of the moieties which are incorporated into the stationary phase material may also be influenced by differences in the reactivity of the moiety or surface modifying agent which attaches the moiety with the solid support. Such differences may be due to the presence of different chemical groups on the moiety or surface modifying agent and differences in the steric bulk of the moiety (for larger and/or more sterically demanding moieties, fewer of the total available reactive positions on the solid support may physically be reacted).

The product obtained from the above preparation may optionally be further reacted with an end-capping reagent. The end-capping reagent may be a relatively small silane reagent, for example, LSiR^{e}₃, wherein L is a reactive chemical group such as a leaving group and R^{e} is an alkyl group having 1 to 4 carbon atoms. The end-capping reagent serves to react with reactive groups on the solid support that remain unreacted following the reactions of the solid support in which surface moieties are attached.

F. Chromatography Apparatus Containing the Stationary Phase Material

The stationary phase material according to the present invention may be employed in methods of separating chemical species by chromatography.

In an embodiment of the present invention, the stationary phase material material may be in bead form and packed into a chromatography column, for example a column of from 1 mm to about 10 mm in diameter and about 10 mm to about 150 mm in length. A carrier phase containing a sample which comprises the species to be separated may be passed through the column.

Typically, the column is hung vertically and the carrier phase passes through the column by virtue of gravity. The species are separated based on the level of affinity each specie has with the stationary phase material with species having a greater affinity being retarded during their passage through the column to a greater extent that species with a lower affinity. As a result, the species may be separately eluted from the column. The carrier phase may be contained initially in a reservoir which is attached to one end of the column and which releases the carrier phase so that it is passed through the column. A pump, for example, a mechanical or syringe pump, capable of pumping the carrier phase through the column may be employed. An injector, capable of introducing one or more chemical species into the column may be employed also. In such an embodiment, the species may be first introduced into a carrier phase and then injected. The column may also be connected to a detector, for example, an ultraviolet spectrophotometer, which is capable of detecting and optionally analyzing the separated chemical species that are eluted from the column. The column may also be connected to a fraction collector which collects portions of the carrier phase containing the various separated species in a plurality of separate containers such that the each specie may be handled separately.

In an embodiment of the present invention, the stationary phase material material may be present on a thin layer chromatography plate, for example, a plate with dimensions of from about 0.5 inches to about 8 inches in length by about 2 inches to about 11 inches in width and about less than 1 mm to about 5 mm in thickness. In such an embodiment, the entire plate may be made of the stationary phase material or the plate may comprise a substrate, for example glass or a polymer film, which is covered on, at least one side, with the stationary phase material. In the later instance, the stationary phase material may, for example, be in the form of beads deposited on the surface of the plate or the stationary phase material may be mixed with an inert binder, for example, gypsum or a high molecular weight, aliphatic, crosslinked polymer, and spread on the substrate. In such instances, the thickness of the layer containing the stationary phase material is typical from about 0.1 to about 0.25 mm for analytical purposes and from about 1 to about 2 mm for preparative thin layer chromatography. A carrier phase containing a sample which comprises the species to be separated may contacted with and be passed along the stationary phase material on the plate. The species are separated based on the level of affinity each specie has with the stationary phase material with species having a greater affinity being retarded during their passage through along the plate to a greater extent that species with a lower affinity. The carrier phase may be contained initially in a reservoir which is attached to one end of the plate and which releases the carrier phase so that it is passed along the plate. An injector, capable of introducing one or more chemical species onto the plate may be employed also. In this embodiment, the species may be first introduced into a carrier phase and then injected.

The stationary phase material may be employed also in solid phase extraction (SPE) processes. For use in SPE, a “solid phase extraction cartridge” which comprises the stationary phase material may be employed. Each cartridge contains a suitable amount of the stationary phase material, for example from about 25 mg of the material to about 100 g of the material. Housings of various shapes, sizes and configurations, for example cylindrical columns, may be used as the cartridge. The cartridge may be designed as disposable units or designed for repeated use. Multiple cartridges may be used in an SPE process. A carrier phase containing a sample which comprises the species to be separated may be contacted with the cartridge. The species are separated based on the level of affinity each specie has with the stationary phase material with species having a greater affinity being retarded during their passage through the cartridge to a greater extent that species with a lower affinity. The carrier phase may be contained initially in a reservoir which is attached to one end of the cartridge and which releases the carrier phase so that it is passed through the cartridge. A pump, capable of pushing the carrier phase through the cartridge may be employed. Alternatively, or in addition, a vacuum, capable of pulling the carrier phase through the cartridge may be employed.

The instrumentation and techniques for using compositions according to the invention for chromatographic separations, including column chromatography, high performance liquid chromatography (HPLC), thin layer chromatography (TLC), flash chromatography, solid phase extraction, and other forms of chromatographic separation can be understood and employed by those skilled in the art.

### EXAMPLES

The practice of the invention is illustrated by the following non-limiting examples.

Examples 1 to 4 relate to the preparation of surface modifying agents for use in the present invention.

### Example 1

To a solution of α,α-dichloroxylene (175 g; 1 mole) in tetrahydrofuran (400 mL) at 0° C. is added allylmagnesium chloride (2.0 M in tetrahydrofuran; 300 mL). The mixture is stirred for four hours and allowed to warm to room temperature. The suspension is filtered and the salts washed with several portion of ether. The filtrate and the ether extracts are washed with sufficient 0.1M HCl solution to give an acidic aqueous layer. The filtrate is then washed with saturated sodium chloride (500 mL) and dried over magnesium sulfate (5 g). After filtration to remove magnesium sulfate, the solvent is removed and the product, H₂C═CH—(CH₂)₂—C₆H₄—CH₂Cl, is isolated by vacuum distillation.

A solution of vinylbenzylmagnesium chloride is prepared by addition of vinylbenzyl chloride (91.6 g; 0.60 mol) in ether (240 mL) to Mg metal (15.3 g; 0.63 mol) in ether (240 mL) containing a crystal of iodine. After four hours the mixture is added to a solution of H₂C═CH—(CH₂)₂—C₆H₄—CH₂Cl (112.4 g; 0.55 mole) in ether (160 mL) at 0° C. The mixture is allowed to stir and warm overnight. The suspension is filtered and the salts washed with several portion of ether. The filtrate and the ether extracts are washed with sufficient 0.1M HCl solution to give an acidic aqueous layer. The filtrate is then washed with saturated sodium chloride (500 mL) and dried over magnesium sulfate (5 g). The magnesium sulfate is filtered off and the solvent is removed by rotary evaporation to give C₆H₅—(CH₂)₂—C₆H₄—(CH₂)₂—CH═CH₂.

### Example 2

To a solution of α,α-dichloroxylene (175 g; 1 mole) in ether (400 mL) at 0° C. is added benzylmagnesium chloride (2.0 M in ether; 300 mL). The mixture is stirred for four hours and allowed to warm to room temperature. The suspension is filtered and the salts washed with several portion of ether. The filtrate and the ether extracts are washed with sufficient 0.1M HCl solution to give an acidic aqueous layer. The filtrate is then washed with saturated sodium chloride (500 mL) and dried over magnesium sulfate (5 g). After filtration to remove magnesium sulfate, the solvent is removed and the product, phenethylbenzyl chloride is isolated by vacuum distillation.

A solution of vinylbenzylmagnesium chloride is prepared by addition of vinylbenzyl chloride (91.6 g; 0.60 mol) in ether (240 mL) to Mg metal (15.3 g; 0.63 mol) in ether (240 mL) containing a crystal of iodine. After four hours the mixture is added to a solution of phenethylbenzyl chloride (91.6 g; 0.55 mol) in ether (160 mL) at 0° C. The mixture is allowed to stir and warm overnight. The suspension is filtered and the salts washed with several portion of ether. The filtrate and the ether extracts are washed with sufficient 0.1M HCl solution to give an acidic aqueous layer. The filtrate is then washed with saturated sodium chloride (500 mL) and dried over magnesium sulfate (5 g). The magnesium sulfate is filtered off and the solvent is removed by rotary evaporation to give C₆H₅—(CH₂)₂—C₆H₄—(CH₂)₂—C₆H₄—CH═CH₂.

### Example 3

C₆H₅—(CH₂)₂—C₆H₄—(CH₂)₂—C₆H₄—CH═CH₂ (20 g; 0.064 mole) is mixed with 100 ppm 1,3-divinyl-1,1,3,3-tetramethyldisiloxane platinum(0). The mixture is heated to 90° C. and dimethylchlorosilane (6.3 g; 0.067 mole) is added dropwise. The temperature is maintained at 90° C. for one hour. The product, C₆H₅—(CH₂)₂—C₆H₄—(CH₂)₂—C₆H₄—(CH₂)₂—Si(CH₃)₂Cl, is isolated by vacuum distillation.

### Example 4

C₆H₅—(CH₂)₂—C₆H₄—(CH₂)₂—CH═CH₂ (20 g; 0.085 mole) is mixed with 100 ppm 1,3-divinyl-1,1,3,3-tetramethyldisiloxane platinum(0). The mixture is heated to 90° C. and diisopropylchlorosilane (12.9 g; 0.086 mole) is added dropwise. The temperature is maintained at 90° C. for one hour. The product, C₆H₅—(CH₂)₂—C₆H₄—(CH₂)₄—Si(C₃H₇)₂Cl, is isolated by vacuum distillation.

### Example 5

This example describes the derivitization of surface silicas on a silica solid support bead to produce a silica solid support bead with a fully hydroxylated surface.

Porous silica beads (13 g, 5 micron diameter, 80 Angstrom pore size) are obtained from Agilent Technologies, Inc. (Palo Alto, Calif.). The silica beads are then treated using the method of J. J. Kirkland and J. Kohler as described in U.S. Pat. No. 4,874,518, the entire disclosure of which is incorporated herein by reference, to yield a fully hydroxylated surface, as follows.

The silica beads are heated at 850° C. for 3 days and then allowed to cool to ambient temperature (about 25° C.). The resulting material is suspended in 130 mL of water containing 200 ppm of HF (400×10⁻⁶ liter of a 50% HF-solution in 1 L of deionized water). The suspension is boiled for 3 days, then allowed to cool to ambient temperature (about 25° C.). The cooled suspension is then filtered through an extra-fine fritted disk. The collected silica beads are washed with 200 mL of deionized water. The silica beads are rinsed with acetone and dried at 120° C. and 0.1 mbar (0.01 kPa) for 15 hours. The dried silica beads are then rinsed successively with 300 mL of a water/ammonium hydroxide-solution (pH=9), rinsed with water to neutrality, and 100 mL of acetone and then dried at 0.1 mbar and 120° C. for 15 hours. The dried silica beads are kept in a dry nitrogen atmosphere until needed.

Examples 6 to 8 describe the reaction of a surface modifying agents with silica solid support beads to produce stationary phase materials of the present invention.

### Example 6

To ten grams of silica solid support bead prepared in Example 5 is added 50 mL of dry toluene under nitrogen. To this mixture is added 1.2 equivalents of pyridine and 1.1 equivalents of the surface modifying agent prepared in Example 3. The resulting mixture is heated at reflux temperature 100° C. for 24 hours, and then cooled to ambient temperature (about 25° C.). The product is collected by filtration. The collected product is washed with 250 mL each of toluene, tetrahydrofuran, methanol and acetone and is then dried overnight (0.1 mbar, 110° C.). The resulting stationary phase material is a silica bead which contains surface moieties of the following structure.

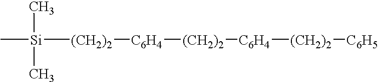

### Example 7

The product from Example 4 is dissolved in heptane (100 mL) and washed with deionized water (100 mL), 0.5% HCl (100 mL), saturated sodium chloride (100 mL), and dried over magnesium sulfate to give a solution of C₆H₅—(CH₂)₂—C₆H₄—(CH₂)₄—Si(C₃H₇)₂OH.

Fifty milliliters of dry toluene is added under nitrogen to ten grams of silica solid support beads. Silica on the surface of the beads had previously been derivatized so that the oxide thereon has been replaced with a leaving group. To this mixture is added 1.2 equivalents of pyridine and 1.1 equivalents of the solution of surface modifying agent, C₆H₅—(CH₂)₂—C₆H₄—(CH₂)₄—Si(C₃H₇)₂OH. The resulting mixture is heated at reflux temperature 100° C. for 24 hours, and then cooled to ambient temperature (about 25° C.). The product is collected by filtration. The collected product is washed with 250 mL each of toluene, tetrahydrofuran, methanol and acetone and is then dried overnight (0.1 mbar, 110° C.). The resulting stationary phase material is a silica bead which contains surface moieties of the structure
C₆H₅—(CH₂)₂—C₆H₄—(CH₂)₄—Si(C₃H₇)₂O—.

Examples 8 and 9 describe the use of chromatography apparatuses containing the stationary phase material of the present invention.

### Example 8

Three grams of the stationary phase material prepared in Example 6 is loaded into a chromatography column of 15 cm in length and 0.46 cm in diameter. A carrier phase comprising a sample, acetonitrile and water is loaded into a reservoir which is attached to a pump (Agilent 1100 series). The pump is used to pump the carrier phase through the column at ambient temperature. An attached ultraviolet spectrophotometer is used to record changes in absorbance with the volume eluted.

### Example 9

Eight grams of the stationary phase material prepared in Example 7 is mixed with high molecular weight, aliphatic crosslinked polymer in tetrahydrofuran to form a slurry. The slurry is then spread on a glass plate of 8 inches in length, 8 inches in width and ⅛ inches in thickness. The material is spread by wiping down the plate with a roller using spacers on each side to control the film thickness to about 250 microns. A carrier phase containing a sample, acetonitrile and water is loaded into a reservoir at one end of the plate. The reservoir releases the carrier phase so that it is passed along the plate. The plate is placed in a developing tank saturated with carrier phase vapor. Development proceeds as the solvent moves up the plate.

1. A surface moiety for use in chromatography which is attached to a solid support, said surface moiety having a structure according to the following formula 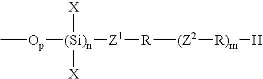
wherein: Z¹ and each Z² is independently a hydrocarbylene group of 1 to 10 carbon atoms which may be substituted or not substituted; each R is independently an arylene group of 6 to 14 carbon atoms which may be substituted or not substituted; each X is independently a hydrocarbyl group of 1 to 6 carbon atoms, a hydrocarbyloxy group of 1 to 6 carbon atoms, an oxygen atom, or a bond at which the surface moiety is attached to the solid support; n is 0 or 1; p is 0 or 1; and m is an integer from 1 to 4, inclusive.

2. A surface moiety according to claim 1 wherein the Z¹ group is a butylene group which may be substituted or not substituted, each Z² group is ethylene which may be substituted or not substituted, and each R group is a phenylene group which may be substituted or not substituted.

3. A surface moiety according to claim 2 wherein n is 1 and the X groups are each individually selected from the group consisting of methyl and isopropyl.

4. A surface moiety according to claim 2 wherein n is 1 and each X group is individually an oxygen atom or a bond at which the surface moiety is attached to the solid support.

5. A surface modifying agent for use in attaching a surface moiety of claim 1 to a solid support, said surface modifying agent being of the formula QₜM wherein M represents said surface moiety; Q is a group which is displaced during the reaction of the surface modifying agent with a reactive chemical group on the solid support; and t is an integer from 0 to 3.

6. A surface modifying agent of claim 5 wherein Q is H and is attached to an oxygen atom.

7. A surface modifying agent of claim 5 wherein Q is a leaving group.

8. A surface modifying agent of claim 7 wherein Q is selected from the group consisting of: F; Cl; Br; an alkoxy group of 1 to 6 carbon atoms; and —NR₁R₂ with R₁ and R₂ being each, individually, an alkyl having 1 to 3 carbon atoms.

9. A surface modifying agent of claim 5 wherein t is 3.

10. A stationary phase material for use in chromatography which comprises a solid support that has, covalently bonded thereto, at least one surface moiety according to claim 1.

11. A stationary phase material according to claim 10 wherein said solid support comprises a metal oxide or a metalloid oxide.

12. A stationary phase material according to claim 10 wherein said solid support comprises silica.

13. A stationary phase material according to claim 10 in the form of a chromatography bead.

14. A stationary phase material according to claim 10 in the form of a porous chromatography bead.

15. A method for making the stationary phase material of claim 10 comprising reacting a solid support having reactive chemical groups thereon with a surface modifying agent of the formula QₜM wherein M represents said surface moiety; Q is a group which is displaced during the reaction of the surface modifying agent with a reactive chemical group on the solid support; and t is an integer from 0 to 3.

16. The method of claim 15 wherein said solid support comprises metal oxide or metalloid oxide on its surface, said reactive chemical group is formed by derivatizing the metal oxide or metalloid oxide on the surface of the solid support so that the oxide is replaced with hydroxyl and said surface modifying agent is one in which Q is a leaving group.

17. The method of claim 15 wherein said solid support comprises metal oxide or metalloid oxide on its surface, said reactive chemical group is formed by derivatizing the metal oxide or metalloid oxide on the surface of the solid support so that the oxide is replaced with a leaving group and said surface modifying agent is one in which Q is a hydrogen atom which is attached to an oxygen atom.

18. A method for making the stationary phase material comprising reacting: (A) a solid support comprising metal oxide or metalloid oxide on its surface wherein a metal oxide or metalloid oxide on the surface has been derivatized such that the oxide is replaced by hydrogen; with (B) a surface modifying agent according to claim 5.

19. A chromatography apparatus comprising the stationary phase material of claim 10.

20. A chromatography apparatus according to claim 19 wherein said stationary phase material is contained in a column.

21. A chromatography apparatus according to claim 19 in the form of a chromatography plate which comprises said stationary phase material.

22. A chromatography apparatus according to claim 19 wherein said stationary phase material is contained in a solid phase extraction cartiridge.

23. A chromatographic separation method comprising contacting a sample comprising species to be separated with the surface moiety of claim 1.

24. A method according to claim 23 wherein said surface moiety is attached to a solid support.

25. A method according to claim 23 wherein said sample is passed through a chromatography apparatus which contains a stationary phase material which comprises said surface moiety.

26. A method according to claim 25 wherein said apparatus is a column.

27. A method according to claim 25 wherein said apparatus is a chromatography plate.

28. A method according to claim 25 wherein said apparatus is a solid phase extraction cartridge.
